(19) United States
(12) Patent Application Publication
(10) Pub. No.: US 2018/0342381 A1
(43) Pub. Date: Nov. 29, 2018

(54) MASS SPECTROMETRY ANALYTE DETECTION AND RELATED METHODS

(71) Applicant: University of Utah Research Foundation, Salt Lake City, UT (US)

(72) Inventors: Geoffrey S. Rule, Salt Lake City, UT (US); Zlatuse D. Clark, North Salt Lake, UT (US); Bingfang Yue, Cedar Hills, UT (US); Alan L. Rockwood, Riverton, UT (US)

(21) Appl. No.: 14/207,346

(22) Filed: Mar. 12, 2014

Related U.S. Application Data
(60) Provisional application No. 61/825,992, filed on May 21, 2013.

(51) Int. Cl. H01J 49/00

(52) U.S. Cl. CPC H01J 49/0036

(57) ABSTRACT

Processes and methods for modeling non-linear calibration behavior resulting from isotopic interference between a target analyte and an internal standard during a mass spectrometry operation are disclosed and described. In some embodiments, a correction to instrument data obtained during the mass spectrometry operation can be made. Such a correction may entail determining, in some cases experimentally determining, one or two constants, and a single adjustable parameter for each analyte/internal standard pair.

### PRIORITY DATA

This application claims the benefit of U.S. provisional patent application Ser. No. 61/825,992, filed May 21, 2013, which is incorporated herein by reference.

### FIELD OF THE INVENTION

The present invention relates to mass spectrometry detection of analytes, including quantification and analysis thereof. Accordingly, this invention involves the field of analytical chemistry as well as related fields.

### BACKGROUND OF THE INVENTION

Stable isotope labeled internal standards are of great utility in providing accurate quantitation in mass spectrometry. An implicit assumption has been that there is no “cross talk” (i.e. interference) between signals of internal standard and target analyte. In some cases, however, naturally occurring isotopes of the analyte do contribute to the signal of the internal standard. This phenomenon becomes more pronounced for isotopically rich compounds, such as those containing sulfur, chlorine, or bromine, higher molecular weight compounds, and at high analyte/internal standard concentration ratio. This can create non-linear calibration behavior which may bias quantitative results.

### SUMMARY OF THE INVENTION

The present disclosure is drawn to the use of a non-linear, but more accurate fitting of data for situations where “cross talk” or interference between an analyte of interest (i.e. target analyte) and an internal standard in mass spectrometry analysis may occur. Generally, speaking, data may be fitted to incorporate one or two constants determined experimentally for each analyte/internal standard combination. Further, adjustable calibration parameters can be used. Such fitting can in some aspects provide more accurate quantitation in mass spectrometry based assays where contributions from analyte to stable labeled internal standard signal exist. It can also correct for the reverse situation where an analyte is present in the internal standard as an impurity.

In one embodiment of the present invention a process for modeling non-linear calibration behavior resulting from an isotopic interference from target analyte to internal standard is established. Such a process allows for a correction to be applied to instrument data and provide more accurate quantitation in mass spectrometric analyses where the interference exists. In another embodiment of the present invention, a process for correction due to a contribution from internal standard to the analyte is also provided. These corrections generally entail the experimental determination of one or two constants and a single adjustable parameter for each analyte/internal standard pair. The use of these parameters, along with the appropriate mathematical computation allows for the inherent quantitative bias, arising in many analyte/internal standard systems, to be corrected.

In further embodiments, it is possible to implement the processes of the present invention as either a correction to a linear relationship or to base the method directly on a particular non-linear method, (i.e. to calculate the result directly rather than as a correction to a linear result). In this case the methods of the present invention are effectively used to generate the non-linear calibration curve for the mass spectrometry operation. It should be noted that in some aspects, whether performed as a correction or used as a direct application, the methods of the present invention reach the useful result of improved data accuracy nevertheless.

Additionally, embodiments of the present invention allow for mass spectrometric analyses to span a broader quantitative range with more accurate quantitative reporting. In addition, invention embodiments allow for the use of analyte/internal standard combinations that would otherwise be impractical owing to their non-linear behavior. As a result, less expensive internal standards, having improved chromatographic performance (as a result of lesser deuterium atom labeling, in the case of deuterated internal standards, thereby leading to more preferred co-elution of analyte and internal standard), can be utilized. Internal standard concentration can also be largely disregarded as a determinant of quantitative accuracy and as a contributor to analyte signal at low analyte concentrations.

Further, embodiments of the present invention allow mass spectrometric analyses to be performed with better accuracy across broader range of concentrations. Quantitative results are therefore more accurate, leading to greater analytical confidence, and there is lessened requirement to repeat sample analysis a second or subsequent time for measurement after dilution. In addition, there is greater freedom to choose less expensive internal standards having less mass labeling and preferred chromatographic properties in comparison with the analyte. Use of the invention also allows internal standard concentration to be selected without regard to the described analyte to internal standard, and internal standard to analyte, interferences.

In other embodiments, methods of quantifying a target analyte in a mass spectrometry sample are provided. Such methods may generally include, collecting data about an isotope-labeled internal standard for a target analyte from a mass spectrometer with a data module of a computing device; collecting data about a sample being tested for the target analyte from the mass spectrometer with a data module of a computing device; correcting the collected data for isotopic interference with any target analyte in the sample, or with the internal standard, or with both; quantifying the target analyte in the sample using the corrected data; and reporting quantification of the target analyte in the sample. In some embodiments the quantified value may be or represent a concentration of the target analyte in the sample. In other embodiments, the quantified value may be or represent other properties or aspects of the target analyte.

In one embodiment, methods are provided for modeling non-linear calibration behavior of mass spectrometry resulting from isotopic interference between a target analyte and an internal standard. Such a method may include obtaining data output from a mass spectrometry operation with a data collection module of a computing device, and processing the data by utilization of one or two constant values and an adjustable parameter value for each target analyte/internal standard pair, and applying a non-linear regression equation with the constant values and adjustable parameter value to the data using a non-linear regression algorithm on a data correction module of a computing device.

In addition to the methods disclosed herein, the present technology additionally encompasses systems for quantifying a target analyte in a sample analyzed with a mass spectrometer. In one example, such a system may include: a data collection module for collection of data output by a mass spectrometer; and a data correction module for correcting data collected by the data collection module. The data correction module may have a non-linear regression logic algorithm that includes one or more non-linear regression equations as recited herein. The system may also a quantification module programmed with an algorithm capable of determining correct peak area for the target analyte using the corrected data and converting the peak area determination into a quantification value for the target analyte in the sample; and a reporting module for reporting the target analyte concentration in the sample. In some embodiments, the modules may be contained on or in communication with a computing device capable to operating said modules, such as those generally disclosed herein.

In yet additional embodiments, the present invention employs computing devices for collection and analysis of data obtained from a mass spectrometer. Such computing devices may include all processors, modules, and program logic necessary to the effective collection, correction, interpolation, or analysis of the data obtained.

### BRIEF DESCRIPTION OF THE DRAWINGS

FIG. 1 is a depiction of contributions to target ion intensity (I_{T}) and internal standard ion intensity (I_{I}) from the target analyte M+0 isotope (F1), a heavy isotope (F2), unlabeled impurity in Internal Standard (IS) (F3), and heavy labeled IS (F4).

FIG. 2 shows extracted ion current chromatograms illustrating the contribution to the IS transition (solid fill) from the M+3 isotope of analyte but in the absence of IS.

FIG. 3 shows a plot illustrating Isotope to Internal Standard Interface (IISI) effect on curve shape, taken to high concentration extreme. Plots are for an example compound with R∞=200, R0=0, A=1, and CI=75 (arbitrary concentration units). The linear fit illustrates, in exaggerated fashion, the relationship to “true” data where IISI exists.

FIG. 4 shows a dansylated estradiol showing position of deuterium atoms on IS and two most abundant fragment ions.

FIG. 5 shows a graphical comparison between an extrapolated linear regression (dashed line) with the extrapolated non-linear fit (solid line) for dansyl estradiol. Calibration standards used to determine the regression parameters in each case can extend up to 200 pg/mL (inset). The individual points shown in the plot are from a set of test samples that were not used for either regression fitting of the calibrators.

FIG. 6 shows Structure of HTRZ showing position of deuterium atoms on IS.

FIG. 7 is a plot of HTRZ data showing non-linear regression (solid line), the 1/X2 weighted linear regression (upper dashed line), and unweighted linear regression (lower dashed line). In the inset, the relative position of the two linear fits is reversed, i.e., the upper dashed line is unweighted.

FIG. 8 is a block diagram of a system and method in according to one embodiment of the present invention.

FIG. 9A is a table of values containing simple figures of merit that can be utilized to compare the likely extent of non-linearity with different analyte/IS combinations and method scenarios.

FIG. 9B is also a table of values containing simple figures of merit that can be utilized to compare the likely extent of non-linearity with different analyte/IS combinations and method scenarios.

### DETAILED DESCRIPTION

Quantitative mass spectrometry often makes use of stable isotope-labeled internal standards (SIL-IS). Quantitation is based on the ratio between analyte (i.e. target analyte) and internal standard (IS) signals. IS's are used to correct for variations in sample preparation, injection, ionization, instrument performance, and the like. While operation without an IS is possible, the drawback of omitting an IS is reduced accuracy and precision.

Although seldom explicitly stated, certain assumptions are often made about calibration curves, in particular that the analyte does not interfere with the IS, and the IS does not interfere with the analyte. Although this is often a reasonable assumption, it is seldom strictly true, and cases where such interferences are significant, particularly when one considers isotopic peaks, have been noted. These effects can lead to a calibration relationship that is non-linear or that has a non-zero intercept. In cases where there is a contaminant in the IS, for example, the IS can interfere with the analyte and produces a non-zero intercept. This is referred to as “contaminant interference” (CI). The case where an analyte isotope interferes with the internal standard and produces non-linearity is referred to as “isotope to IS interference” (IISI). These two effects can occur either singly or in combination, depending on the system under consideration.

Use of non-linear curve fitting or in some aspects, quadratic curve fitting, for calibration in both bioanalytical and clinical chemistry fields is not generally condoned or accepted. In the context of the present application, the term “non-linear” refers to non-linearity of the calibration curve with respect to an independent variable, (i.e. non-linear with respect to analyte concentration). The terms “non-linear” and “quadratic” are often considered synonymous but, as used herein, the two are considered distinct. In particular, although all quadratic equations are non-linear, not all non-linear equations are quadratic, and for important classes of calibration data certain non-quadratic non-linear equations may appropriately be used as calibration functions. As used herein, “calibration” refers to calibration for quantitative analysis and not calibration of the m/z scale.

As used herein, “analyte” and “target analyte” may be used interchangeably. The plain and ordinary meaning of such terms is well known to those of ordinary skill in the art and such meaning is afforded herein.

The appearance of non-linear calibration curve data is not uncommon, and the cause of this behavior is not always obvious. Several causes can account for it, including detector saturation, dimer/multimer formation, and an isotope effect. “Self-suppression”, or reduced ionization efficiency at higher analyte concentrations, can be a cause when using an analog IS, but is not generally an issue when co-eluting SIL-IS are used. At times, non-linear behavior may create obvious quantitative biases when choosing a linear fit and it may limit the dynamic range for the assay. At other times the bias may be less obvious but present nevertheless.

Rather than fitting some arbitrarily chosen non-linear calibration function to a set of calibration data, embodiments the present disclosure (or technology) selectively harness an approach based on mathematical equations deriving from a realistic physical model and properties that can be experimentally determined for each analyte/IS pair. Thus, greater precision of detection can be achieved with much reduced error.

Industry guidelines generally help to control the extent of these effects. In the bioanalytical setting, for example, a recommendation may be made to limit the contribution from an analyte isotope, to the IS signal, to 5% or less at the highest concentration. In effect, this measure may require use of higher than desirable IS concentrations, due to CI, or limiting the dynamic range of the assay.

In the clinical chemistry setting it is not unusual to have assays that use relatively low concentration calibrators for daily analysis, and to use a linear extrapolation for quantitation to a higher analyte concentration. In this scheme, the full range, including the extrapolated region, is known as an analytical measurement range (AMR). Exemplary reasons for extrapolation in this fashion may be due to a limited number of samples falling in the upper regions of the desired range, a desire to limit the number of calibrators used, or because of issues related to carryover. Furthermore, inclusion of higher-concentration calibrators may produce greater error in the low-concentration region of the calibration line, either through statistical variability or as a result of an underlying non-linear calibration relationship. The result of a linear extrapolation however, can be a systematic quantitative bias at higher levels resulting from IISI.

These circumstances are not always under laboratory control and, for example, it may be necessary to use a less ideal IS or concentration due to cost, availability, and/or purity. In other situations, IS's that are highly labeled with deuterium may suffer chromatographic separation from the analyte itself, thus detracting from their usefulness or, with endogenous compounds, interferences may exist that limit the choice of internal standard to one that is less desirable in other ways. Furthermore, in cases where both IISI and CI exist, one can change the IS concentration to reduce the extent of one interference only at the expense of increasing the other.

In some cases a quadratic fit may be contemplated for non-linear data, but it should be noted that this is, at a fairly fundamental level, an improper fit since it is parabolic if taken to very high concentrations and has the wrong asymptotic behavior. Alternatively, linear fits may be chosen with some form of weighting to provide better accuracy (on a compromise basis) across the range of interest. In this case, it may be observed that high concentrations are consistently biased low. This may be accepted so long as the deviation from the regression line is not too significant.

In embodiments of the present disclosure, various techniques can be used to provide a more accurate fit to isotope-caused, non-linear MS data. The following equations, for example, use one or two experimentally determined constants and a single adjustable parameter determined for each set of calibration points. These equations can be used to correct for both the IISI as well as the offset that occurs in the y-intercept from CI (in some cases CI may be due to background interference that exists with endogenous compounds in some matrices). In some embodiments, the fit can be used to correct for IISI and provide improved quantitative results over those obtained by a strict linear fit.

Although the following detailed description contains many specifics for the purpose of illustration, a person of ordinary skill in the art will appreciate that many variations and alterations to the following details are within the scope of the herein disclosed embodiments.

Accordingly, the following embodiments are set forth without any loss of generality to, and without imposing limitations upon, any claims set forth herein. Before various embodiments are described in greater detail, it is to be understood that this disclosure is not limited to the particular embodiments described. It is also to be understood that the terminology used herein is for the purpose of describing particular embodiments only, and is not intended to be limiting. Unless defined otherwise, all technical and scientific terms used herein have the same meaning as commonly understood by one of ordinary skill in the art to which this disclosure belongs.

As used in this specification and the appended claims, the singular forms “a,” “an” and “the” include plural referents unless the context clearly dictates otherwise. Thus, for example, reference to “an analyte” includes a plurality of such materials.

As used in this specification, “comprises,” “comprising,” “containing” and “having” and the like can have the meaning ascribed to them in U.S. Patent law and can mean “includes,” “including,” and the like, and are generally interpreted to be open ended terms. The term “consisting of” or “consists of” is a closed term, and includes only the components, structures, steps, processes, compositions, systems, or the like specifically listed, and that which is in accordance with U.S. Patent law. “Consisting essentially of” or “consists essentially” are generally closed terms, limiting the components, structures, steps, processes, compositions, systems, or the like, when applied to methods, compositions, or systems specifically listed, as well as other elements that do not substantially alter or effect the basic and novel characteristics of the item to which the “consisting essentially of” language refers. In further detail, “consisting essentially of” or “consists essentially” or the like, when applied to components, structures, steps, processes, compositions, systems, or the like encompassed by the present disclosure have the meaning ascribed in U.S. Patent law. When using an open ended term, like “comprising” or “including,” it is understood that direct support should be afforded also to “consisting essentially of” language as well as “consisting of” language as if stated explicitly and vice versa.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method. Furthermore, the terms “comprise,” “include,” “have,” and any variations thereof, are intended to cover a non-exclusive inclusion, such that a process, method, article, or apparatus that comprises a list of elements is not necessarily limited to those elements, but may include other elements not expressly listed or inherent to such process, method, article, or apparatus.

As used herein, the term “about” is used to provide flexibility to a numerical range endpoint by providing that a given value may be “a little above” or “a little below” the endpoint.

As used herein, the term “correction” when used relative to data associated with a mass spectrometry operation refers to a deviation from a conventional linear calibration relationship, regardless of whether the new relationship is derived by first generating a linear calibration relationship and then modifying the result to a non-linear relationship, or derived by generating a non-linear relationship directly without first generating a linear relationship

As used herein, “substantial” and “substantially” when used in reference to a quantity or amount of a material, or a specific characteristic thereof, refers to an amount that is sufficient to provide an effect that the material or characteristic was intended to provide. The exact degree of deviation allowable may in some cases depend on the specific context. Similarly, “substantially free of” or the like refers to the lack of an identified element or agent in a composition. Particularly, elements that are identified as being “substantially free of” are either completely absent from the composition, or are included only in amounts which are small enough so as to have no measurable effect on the composition.

Reference throughout this specification to “an example” means that a particular feature, structure, or characteristic described in connection with the example is included in at least one embodiment. Thus, appearances of the phrases “in an example” in various places throughout this specification are not necessarily all referring to the same embodiment.

As used herein, a plurality of items, structural elements, compositional elements, functions, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, levels and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges or decimal units encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually. This same principle applies to ranges reciting only one numerical value as a minimum or a maximum. Furthermore, such an interpretation should apply regardless of the breadth of the range or the characteristics being described.

With the above-recited information in mind, the inventors have developed methods for improving accuracy and precision of mass spectrometry generated analytical data. In one aspect, a method of modeling non-linear calibration behavior of mass spectrometry, resulting from isotopic interference between a target analyte and an internal standard is provided.

Such a method may generally include obtaining data output from a mass spectrometry operation with a data collection module of a computing device; and utilizing and/or correcting the data by determining one or two constant values and an adjustable parameter value for each target analyte/internal standard pair and applying the non-linear model using a data correction module with the described non-linear regression logic comprising Equations 1-6 as recited herein or selections thereof. As mentioned herein, the adjustable parameter can in some aspects, be determined at the time of calibration of the mass spectrometry equipment for operation. Additionally, as mentioned herein, data of the adjustable parameter can be collected with the other data output from the mass spectrometry operation in certain aspects. In further embodiments, as noted herein, the one or two constant values can be determined experimentally for each analyte/internal standard combination. In some embodiments, the target analyte and internal standard can have different masses. As such, one constant value can be equal to a target analyte of one isotope, divided by a different isotope of the target analyte, and a second constant value can be equal to one isotope of an internal standard divided by a different isotope of the internal standard. In a specific embodiment, one constant value is equal to a target analyte M+0 isotope divided by a heavy isotope of the target analyte and a second constant value is equal to an unlabeled impurity in an internal standard divided by a heavy labeled internal standard. Generally speaking, the target analyte, or analytical peak, and the internal standard are different in mass.

Another method encompassed by the present invention includes improving testing result accuracy in mass spectrometry testing where interference between an internal standard and an analyte of interest occurs. Such a method may include processing or correcting data obtained from a mass spectrometry operation collected in a data collection module of a computing device using a data correction module with non-linear regression logic comprising Equations 1-6 or selections thereof.

Other methods encompassed by the present disclosure include methods of expanding an effective quantitation range in a mass spectrometry analysis, methods of correcting data obtained from a mass spectrometry operation, and methods of determining the amount of (or concentration of) contents of a sample using mass spectrometry analysis among others.

In some embodiments, the processes or methods of the present disclosure employ a regression equation that provides a more accurate fit to quantitative data in situations where a SIL-IS is used but where IISI exists. Additional considerations provide an optional, adjustment for a CI. Such embodiments encompass tandem mass spectrometry, and specific precursor/product ion combinations, as methods of possible choice for quantitative mass spectrometry, but the present disclosure further encompasses use of single stage mass spectrometry as well.

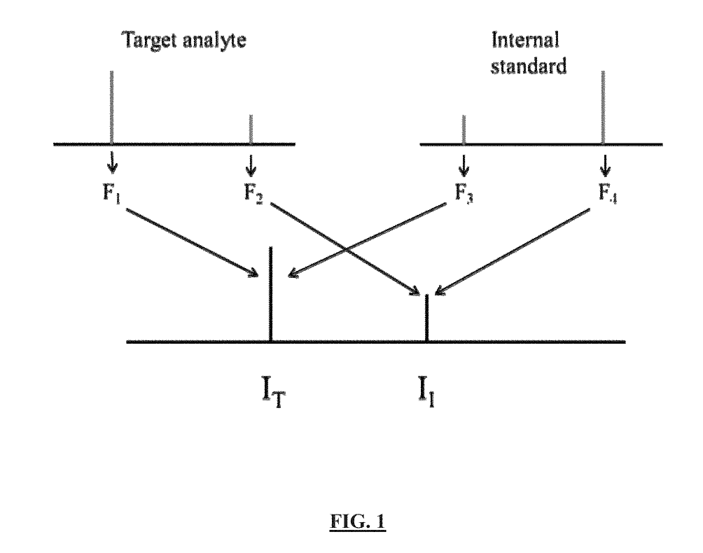

Referring now to FIG. 1, is shown a situation where there are contributions to ion intensities of interest, namely target ion intensity (I_{T}), and internal standard ion intensity (I_{I}), for both the target analyte and the IS respectively. Here, F1 and F2 represent the relative contributions of the M+0 precursor (analyte) and the relevant heavy isotope (or they can simply represent different isotopes of the analyte), to the product ion(s) of interest, respectively. F3 and F4 are the relative contributions from CI and the labeled IS, respectively. FIG. 1 illustrates I_{T} and I_{I} as being of different masses, but in some cases the product ions selected may be the same mass. In yet other cases the parent ion masses may be the same, while the product ion masses are different. In additional embodiments, the product ions can be the same mass while the parent ion masses are different (e.g. in the isobaric labeling methods, such as when iTRAQ reagents are used). In some aspects, FIG. 1 can be taken as a general representation of the relative signal intensities of the target analyte and internal standard, regardless of whether the mass spectrometer is single stage (i.e. MS), conventional tandem mass spectrometry (MS/MS) or multi-stage tandem mass spectrometry (MSⁿ). In addition, M+0 is used here for illustrative purposes, but in some cases the analyte peak may be an isotope peak other than M+0. The ion intensities of target analyte and IS masses are calculated according to Equations 1 and 2 as follows:

I_{T}=F₁C_{T}+F₃C_{I} (Equation 1)

I_{I}=F₂C_{T}+F₄C_{I} (Equation 2)

where C_{T} and C_{I} are the respective concentrations for the target analyte and the IS. Correcting for extraction and other process variation, by use of the IS, the peak area ratio used for quantitation is then I_{T}/I_{I}, which can be simplified as R. Also a constant may be defined and represented as R∞ which is equal to F1/F2, and constant R0 as equal to F3/F4. Note that the former, from IISI, is determined by the composition, structure, and fragment selected for the analyte, while the latter, representing the CI, depends on the purity of the IS resulting from a chemical synthesis. In some aspects, a small percentage of a SIL-IS is commonly found to be without isotope labeling and will give rise to CI.

With some substitution and rearrangement, and defining a new parameter, A=F1/F4, the following equation can be established:

$$R = A \frac{( {C}_{T} + \frac{{R}_{0}}{A} {C}_{I} )}{( \frac{A}{{R}_{∞}} {C}_{T} + {C}_{I} )} \qquad ( Equation 3 )$$

Here, A can be treated as an adjustable parameter that is determined at the time of calibration. In other words, A can be treated as an adjustable parameter that is determined separately from R0 or R∞, such as determining it at the time of calibration. This parameter may vary if, for example, different collision energies are used for the analyte and internal standard or if IS concentration is varied.

Equations 1 and 2 are linear functions of the analyte and internal standard concentrations. However, when one forms the ratio (R) between the two, the resulting function is a non-linear function of the analyte and internal standard concentrations. This non-linearity is inherent in a calibration scheme that uses the ratio R as a basis of quantitative analysis. An exception to this rule occurs if R∞=∞, in which case R is a linear function of the analyte concentration.

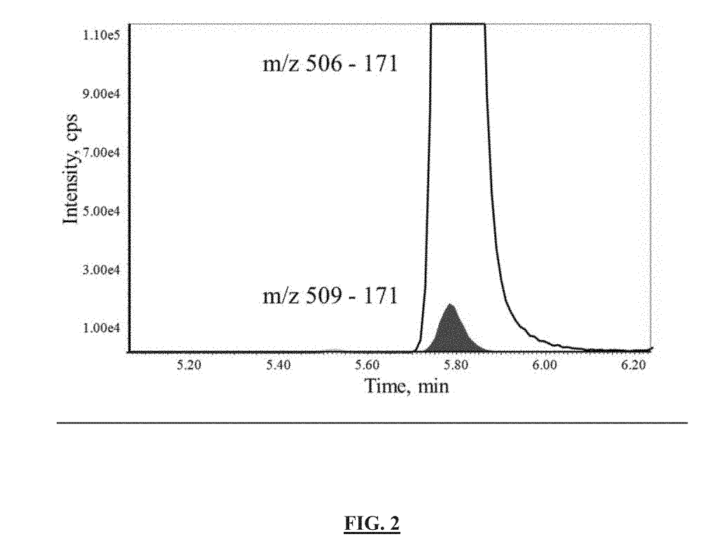

In some embodiments, values for both R∞ and R0 are determined experimentally for each analyte/IS combination, and for each lot of IS, respectively as illustrated in FIG. 2. FIG. 2 generally shows the contribution to the IS transition (solid fill) from the M+3 isotope of analyte but in the absence of IS. R∞ is then the peak area ratio (R) determined when analyte is present but IS is not present.

The ratio of the signals (analyte transition/IS transition, measuring F1/F2) gives R∞. R0 can be determined in a similar fashion, monitoring the same two transitions, but injecting labeled IS without added analyte.

With a set of calibration data points, utilizing both analyte and IS, along with values for R∞ and R0, one can solve for parameter A. A may be determined by use of non-linear regression fitting of equation (3) to experimental data, or by solving Equation 4 for A at several concentrations and determining a representative value for A from the resulting set of values, (e.g. the median or the mean of the set of values, or some other estimate of the best value for A).

$$A = \frac{( {R}_{0} - R ) {C}_{I}}{{C}_{T} ( \frac{R}{{R}_{∞}} - 1 )} \qquad ( Equation 4 )$$

Once A has been determined for a given set of conditions (mass spectrometer, reference standards, and IS concentration) an additional step of the present methods may be to solve CT for any given value of R generated from an unknown sample using Equation 5.

$${C}_{T} = \frac{( {R}_{0} - R ) {C}_{I}}{A ( \frac{R}{{R}_{∞}} - 1 )} \qquad ( Equation 5 )$$

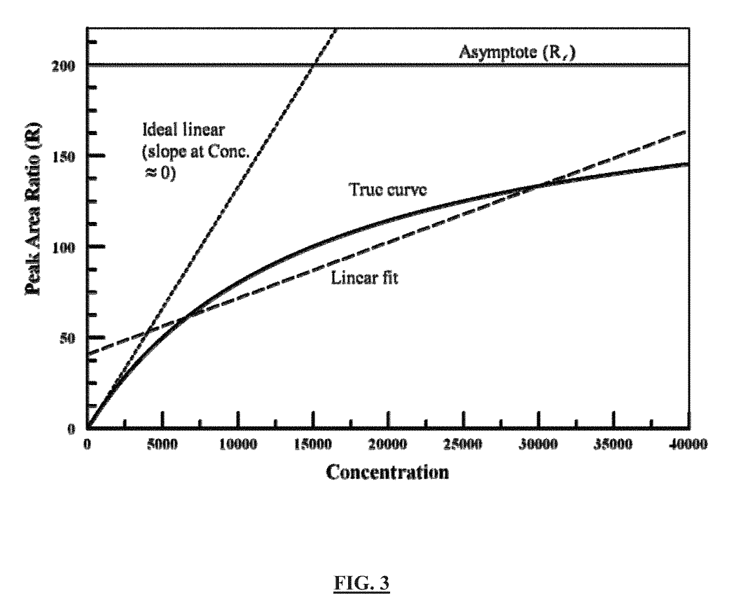

A simulated example of the IISI when taken to high analyte concentration using Equation 3 is shown as the “true curve” of FIG. 3. As shown, FIG. 3 plots IISI effect on curve shape, taken to high concentration extreme. Plots are for an example compound with R∞=200, R0=0, A=1, and CI=75 (arbitrary concentration units). The linear fit illustrates, in exaggerated fashion, the relationship to “true” data where IISI exists.

As seen, the use of a linear fit in this situation results in a negative bias at both high and low concentrations, and a positive bias in the intermediate regions of the curve. The asymptote, R∞, shows the limit that peak area ratio will approach as analyte concentration gets very high and its influence on apparent IS peak area, resulting from IISI, dominates. The use of a quadratic fit in this situation is not of the correct form as it would reach a maximum value of R and then descend or, conceivably, deflect upwards through and beyond the asymptote. That is, a quadratic will approach either positive or negative infinity as concentration increases, rather than approaching an asymptotic value. The “ideal” linear fit shown would occur in a situation with no isotope effect and have a slope equivalent to the tangent at the limit of C_{T}=0. In practice, the effect of utilizing higher IS concentrations serves to force the value of R to lower regions of the curve where the non-linearity is not as extreme.

A positive value of R0, due to CI, equates to a non-zero value for the y-intercept in the calibration plot. In many situations the level of the CI, in addition to auto-sampler carryover, is managed so as to contribute only a small percentage (generally ≤20%) to the lowest calibration standard. This may be performed in part by limiting the concentration of the IS used. In this, or similar situations where CI is negligible, Equation 3 can be simplified as shown in Equation 6. As such, in some aspects, the methods of the present invention may simply include non-linear regression by fitting data to equation 6. The two examples presented below make use of this simplified form.

$$R = \frac{A {C}_{T}}{( \frac{A}{{R}_{∞}} {C}_{T} + {C}_{I} )} \qquad ( Equation 6 )$$

As noted above, R∞ can be determined experimentally by measuring R in a sample containing analyte but no internal standard, and this is the approach used for data analysis herein. However, it is also possible to estimate R∞ using theoretical methods. In a single-stage mass spectrometry experiment, F2, and hence R∞, is determined solely by the abundance of the analyte isotope corresponding to the mass of the internal standard. In quantitative tandem mass spectrometry however, the IISI contribution also depends on the fragment ions being monitored, and on the size and composition of the fragment in relation to the precursor molecule.

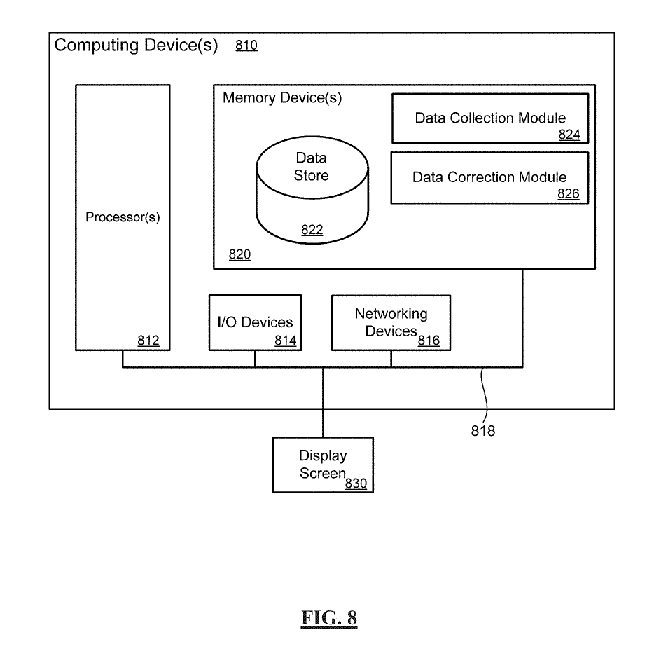

FIG. 8 illustrates an example of a computing device 810 on which modules involved in the present technology may execute. The computing device may be in digital communication with a mass spectrometer (not shown) in a manner sufficient to receive and collect data from the mass spectrometer and to process such data using various included modules. The computing device 810 may include one or more processors 812 that are in communication with memory devices 820. The computing device may include a local communication interface 818 for the components in the computing device.

The memory device 820 may contain modules that are executable by the processor(s) 812 and data for the modules. For example, a data collection module 824, data correction module 826, and other modules may be located in the memory device 820. The modules may execute the functions described earlier. A data store 822 may also be located in the memory device 820 for storing data related to the modules and other applications along with an operating system that is executable by the processor(s) 812. It is to be noted that while not shown, the data collection module 824 and data correction modules 826 need not reside specifically in the memory device 820, but can be separately located on the same logical basis as an I/O device (i.e. in different portion of the computing device, or in one or more separate devices of varying components in communication with the computing device).

Other applications may also be stored in the memory device 820 and may be executable by the processor(s) 812. Components or modules discussed in this description may be implemented in the form of software using high level programming languages that are compiled, interpreted or executed using a hybrid of the methods.

The computing device may also have access to I/O (input/output) devices 814 that are usable by the computing devices. An example of an I/O device is a display screen 830 that is available to display output from the computing devices. Other known I/O devices may be used with the computing device as desired. Networking devices 816 and similar communication devices may be included in the computing device. The networking devices 816 may be wired or wireless networking devices that connect to the internet, a LAN, WAN, or other computing network, or to a mass spectrometer or other testing equipment, or a portion or component thereof.

The components or modules that are shown as being stored in the memory device 820 may be executed by the processor 812. The term “executable” may mean a program file that is in a form that can be executed by a processor 812. For example, a program in a higher level language may be compiled into machine code in a format that may be loaded into a random access portion of the memory device 820 and executed by the processor 812, or source code may be loaded by another executable program and interpreted to generate instructions in a random access portion of the memory to be executed by a processor. The executable program may be stored in any portion or component of the memory device 820. For example, the memory device 820 may be transitory or non-transitory. For example, the memory device can be random access memory (RAM), read only memory (ROM), flash memory, a solid state drive, memory card, a hard drive, optical disk, floppy disk, magnetic tape, or any other memory components.

The processor 812 may represent multiple processors and the memory 820 may represent multiple memory units that operate in parallel to the processing circuits. This may provide parallel processing channels for the processes and data in the system. The local interface 818 may be used as a network to facilitate communication between any of the multiple processors and multiple memories, and in some aspects a mass spectrometer or other testing equipment, or a portion or component thereof. The local interface 818 may use additional systems designed for coordinating communication such as load balancing, bulk data transfer, and similar systems.

### EXAMPLES

The following examples are provided to promote a more clear understanding of certain embodiments of the present disclosure, and are in no way meant as a limitation thereon. Examples 1 and 2 below are representative of embodiments of the present disclosure. Example 1 involves the testing and determination of estradiol and Example 2 involves the testing and determination of HTRZ. The following materials and methodology are used in connection with these examples.

Methods and Materials

Computations are done using PSI-Plot (version 10, Poly Software International, Pearl River, N.Y.) with user defined equations and the built-in Levenberg-Marquardt dampened least squares algorithm for determination of adjustable parameter A defined in the equations included herein.

Reference materials hydroxytriazolam (HTRZ), estradiol, and internal standards (d4-HTRZ and d3-estradiol respectively) are purchased from Cerilliant (Round Rock, Tex.) or CDN Isotopes (Pointe-Claire, Quebec, Canada), respectively. Solvents are purchased from J. T. Baker and water is prepared in-house using an 18 MOhm resin purification system. Formic acid and dansyl chloride are from Fluka (Sigma-Aldrich, St. Louis, Mo.).

For estradiol the assay calibrators are placed at 5, 20, 50, 80, 120 and 200 pg/mL serum. Analytical measurement range (AMR) is often extended up to 2000 pg/mL, but here additional test samples are evaluated up to 4000 pg/mL. The IS is used at a concentration equivalent to 200 pg/mL serum. Estradiol is extracted from control serum using methyl t-butyl ether extraction followed by derivatization with dansyl chloride. The dansylation reaction is carried out by combining equal volumes of a solution of dansyl chloride (1 g/L) with 10 mM sodium carbonate buffer and adding 50 uL of this solution to each sample well of a 96-well plate. The plate is covered and then incubated at 70° C. for 10 minutes. A reconstitution solution of 1:1 water:acetonitrile (50 uL) is then added prior to injection. The method and analysis of estradiol is performed using a column switching system.

Typical calibration range for HTRZ in urine covers 20 to 200 ng/mL with the AMR extended up to 5000 ng/mL. A d4-IS is used at a concentration equivalent to 100 ng/mL in urine, or 2% of the upper concentration limit. Calibrators are set at seven concentrations of 0.25, 1, 2.5, 10, 25, 100, and 250 ng/mL, each in a solution of 75% water, 25% acetonitrile, and injected 20 uL on column. Concentrations are adjusted downward due to use of a more sensitive instrument for these studies than typical laboratory assay. The d4-HTRZ IS is also used at 2% of the upper concentration limit or 5 ng/mL. The chromatographic conditions used for HTRZ are on a Waters XTerra® MS C18 analytical column (2.1×150 mm) with 3.5 μm particle size, and a generic gradient of acetonitrile and water, each containing 0.1% formic acid.

Data are generated on an AB Sciex API 5500 mass spectrometer using a Turbo Ionspray source in positive ion mode and within the linear response range of the detector (taken to be approximately 4×10⁶ cps). Transitions monitored for dansyl estradiol and d3-dansyl estradiol were 506 to 156 and 171, and 509 to 156 and 171 amu, while for HTRZ and d4-HTRZ, 359.3 to 176 and 363.3 to 176 amu, respectively. Quantitation is done using Analyst software version 1.5.2.

### Example 1—Quantification of Estradiol

For estradiol quantitation the AMR covers 1-2000 pg/mL. As mentioned, calibrators for each batch span the range of 5 to 200 pg/mL and IS is added at a concentration of 200 pg/mL. When it is necessary to analyze a sample whose concentration is above that of the highest calibrator but lower than the upper limit of the AMR, the calibration curve is extrapolated outside of the range covered by the calibrators. Necessary conditions for this to be valid are that the extrapolated calibration curve should be well-behaved and be of a functional form that gives a good representation of the data.

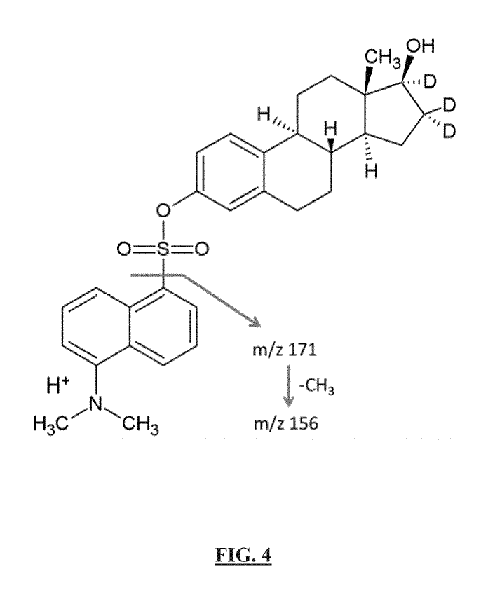

To obtain highest sensitivity for this assay a dansyl derivative a shown in FIG. 4 is used. The sulfur containing dansyl moiety contributes a relatively large M+2 isotope (³⁴S has an average of 4.21% of ³²S abundance) to the compound. Together the naturally occurring heavy isotopes of this compound combine to yield an M+3 contribution that is of 2.5% that of the M+0 component.

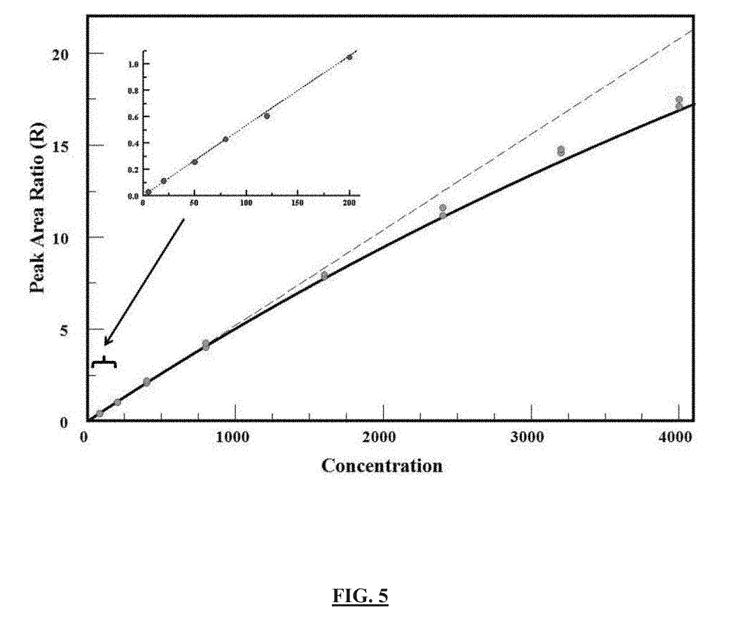

For data analysis, a value of R∞ is determined experimentally using the method discussed earlier herein. With an R∞ value of 79 and, setting R0=0, Equation 4 as previously provided is used with data from a set of calibration standards (at 5, 20, 50, 80, 120 and 200 pg/mL) to generate a mean value of A that is 1.075. This value is then used with Equation 3 as previously provided to generate ideal peak area ratios (R) shown extended across the concentration range of interest as the solid line in FIG. 5. An un-weighted linear regression is used with the same calibration standards to generate the dashed line shown extrapolated to the upper quantitation limit of in FIG. 5. A separate set of samples are analyzed at the same time, using eight concentrations each in duplicate, and the concentrations calculated from both the linear equation and according to the non-linear fit of previously provided Equation 5. Values are provided in Table 1.

The FIG. 5, along with Table 1A, shows the accuracy obtained with the non-linear fit, in comparison to a linear one, after extrapolation beyond the upper calibration standard (200 pg/mL) in each case. Table 1B shows accuracy values obtained for each case with the calibration standards themselves. This data suggests that in such cases it is possible to remove some of the systematic bias that occurs with high concentration quantitation, when IISI exists, and where a regression is extrapolated beyond the level of the daily calibration standards. The non-linear calibration relation gives very good accuracy, both within and outside of the calibration range, whereas the linear calibration relationship fails to give an accurate result at the higher concentrations.

TABLE 1
Table 1: Percent accuracy as determined by two fitting approaches.
A) Mean of two replicate determinations of the test samples
evaluated by both linear and non-linear calibration, including
high-concentration samples beyond the 200 pg/mL upper limit
of the calibrators. B) Back-calculated accuracy for each of
individual calibrators used to generate the parameters for
each regression approach. In both cases percent accuracy is
determined as the concentration calculated from the regression
line divided by theoretical concentration.

| | | |
|---|---|---|
| Concentration | Nonlinear | Linear |
| (pg/mL) | Accuracy (%) | Accuracy (%) |

A

| | | |
|---|---|---|
| 80 | 98.7 | 101 |
| 200 | 98.0 | 99.9 |
| 400 | 102 | 103 |
| 800 | 101 | 99.3 |
| 1600 | 102 | 95.0 |
| 2400 | 103 | 91.2 |
| 3200 | 105 | 88.2 |
| 4000 | 103 | 83.1 |

B

| | | |
|---|---|---|
| 5 | 106 | 96.1 |
| 20 | 105 | 106 |
| 50 | 95.2 | 97.3 |
| 80 | 100 | 103 |
| 120 | 94.2 | 96.7 |
| 200 | 99.0 | 101 |

### Example 2—Quantification of Benzodiazepine Compound

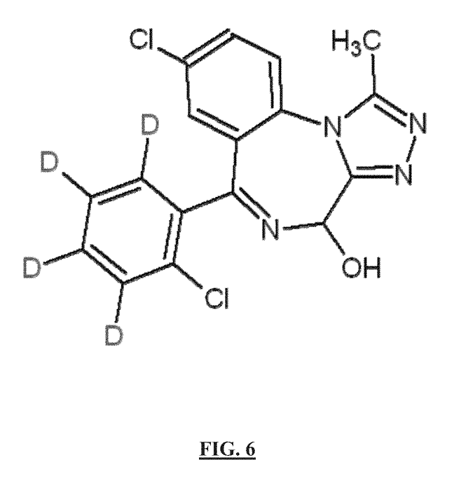

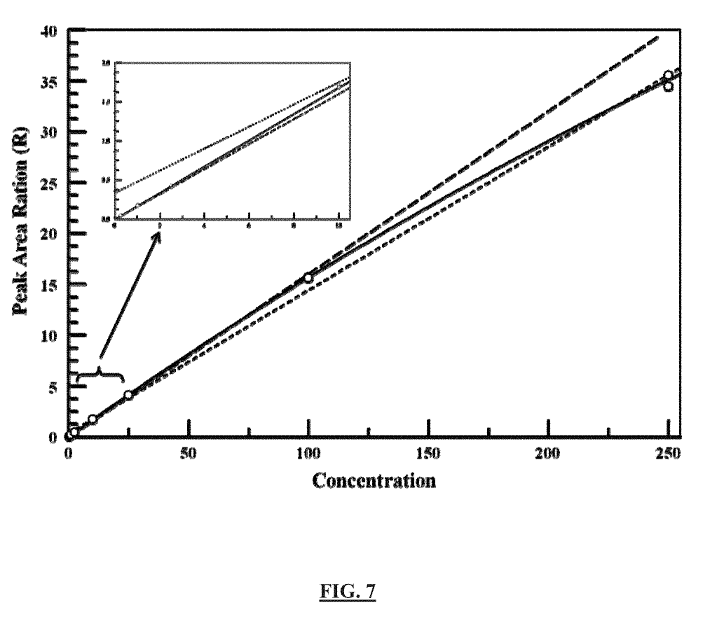

In a second example the influence of IISI on curve linearity for HTRZ, a compound in the benzodiazepine class is determined. The structure of this compound is shown in FIG. 6. In this case, the compound contains two chlorine atoms giving a substantial M+4 peak (12% of monoisotopic mass) at the same mass as the d4-IS utilized for this assay. Separate experiments determine that the fragment ion utilized for quantitation (mass of 176 amu) bears one chlorine atom but none of the deuterium atoms. An experimental determination of R∞ (203) provides the non-linear fit to calibration data as shown in FIG. 7, with an A parameter of 0.8487. For comparison, both weighted and un-weighted linear fits are shown. In this example the data is treated without extrapolation, as would be done for a bioanalytical analysis, though with a relatively low IS concentration. All levels of calibration standards, each in duplicate, are used for regression. For each regression type, back-calculated concentrations are generated for each calibration level across the quantitation range.

As seen in Table 2, the use of an un-weighted linear fit does not suffice across the 1000 fold concentration range of this example, due to the non-linearity of the data. The y-intercept is pulled exceedingly high resulting in nonreportable (negative) values of concentration at the low end of the curve.

TABLE 2
Table 2: Comparison of back-calculated accuracy values
for HTRZ with use of various fitting options.

| | | Linear | Linear | |
|---|---|---|---|---|
| | Linear | (1/X | (1/X² | |
| | (Unweighted) | weighting) | weighting) | Non-linear |
| r value | 0.9988 | 0.9979 | 0.9973 | 0.9998 |
| Std 1 0.25 ng/mL | no value | 59.5 | 98.3 | 107 |
| Std 2 1 ng/mL | no value | 104 | 106 | 104 |
| Std 3 2.5 ng/mL | 22.6 | 109 | 104 | 100 |
| Std 4 10 ng/mL | 96.3 | 114 | 106 | 101 |
| Std 5 25 ng/mL | 107 | 111 | 102 | 99 |
| Std 6 100 ng/mL | 109 | 107 | 97.8 | 100 |
| Std 7 250 ng/mL | 98.5 | 95.6 | 87.4 | 99.9 |

Use of a 1/X weighted fit improves the quantitation at low concentrations, although the dynamic range is still limited by inaccuracies at lower concentrations. A noticeable positive bias is also seen at intermediate concentration levels.

The 1/X2 weighting further pulls the fit toward more accurate values at the lower, linear region of the curve. However, accuracy is now beginning to degrade at the higher concentrations, nearly approaching an unacceptable limit of 15% error. In this case it would be expected that a relatively high proportion of analytical runs may fail due to excessive deviation at the highest calibration concentration. In addition, any sample determinations reported from the high end of the range in this situation would be biased low. The root mean square (RMS) percentage error of the seven data points is 6.4%

In contrast with the linear calibration relations, the non-linear calibration produces good accuracy over the full concentration range studied. The r value (0.9998), the RMS percentage error (3.1%), and the maximum error (7%) are all superior to any of the linear fits.

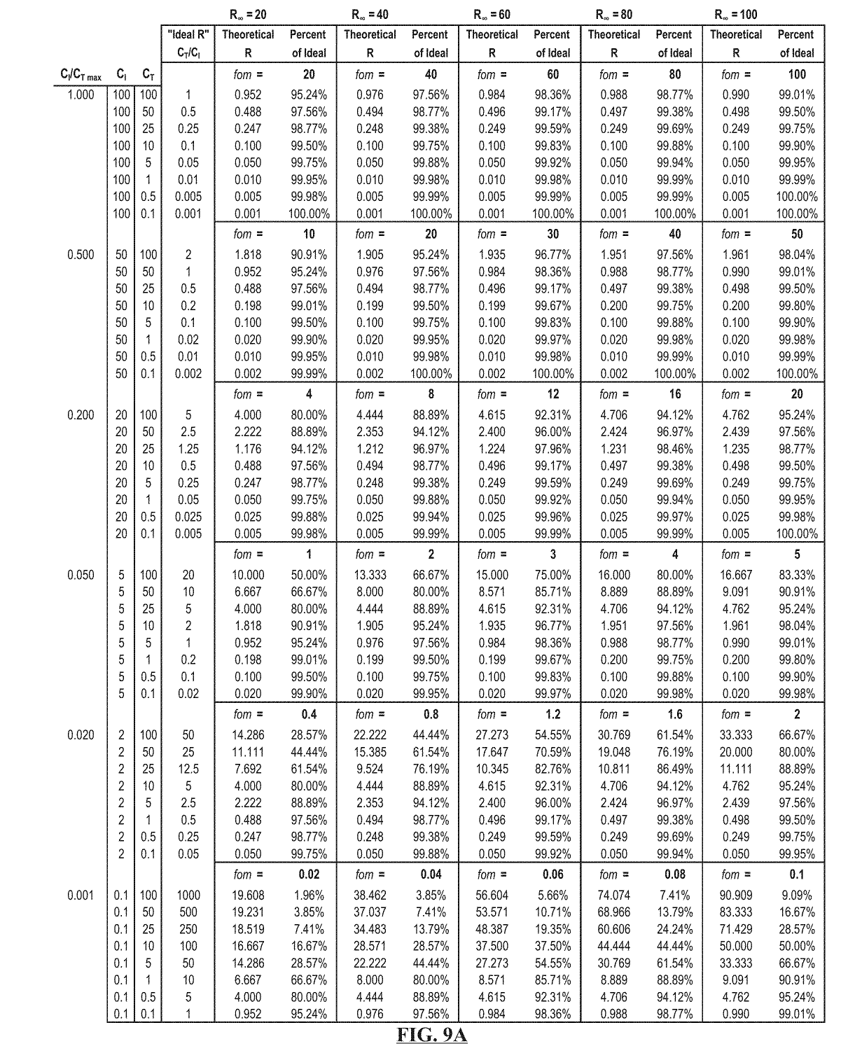

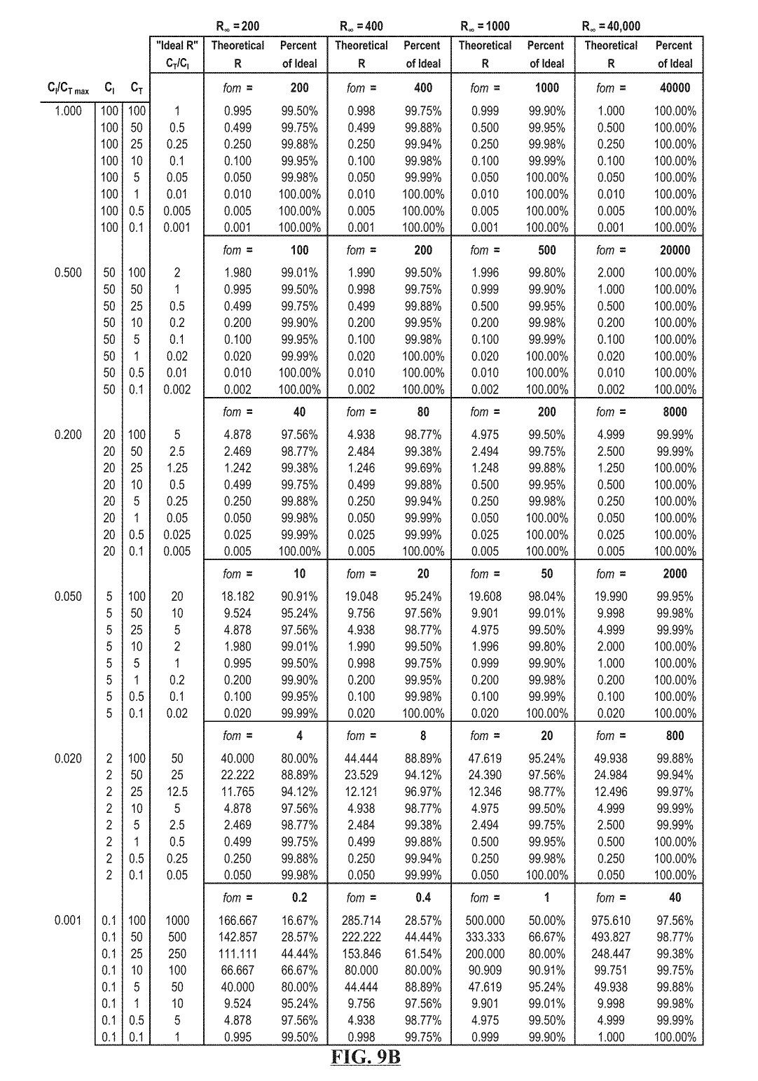

In some embodiments, the chance or probability of non-linearity and the extent thereof can be identified, determined, or otherwise estimated. For example, in some embodiments a simple figure of merit can be utilized to compare the likely extent of non-linearity with different analyte/IS combinations and method scenarios as shown in FIG. 9. As can be seen, FIG. 9 allows a simple comparison of different situations with regard to the degree of nonlinearity that may be expected for different R∞ values and C_{I}/C_{T} max ratios. The figure of merit (fom) is equivalent to R∞ multiplied by the C_{I}/C_{T} max ratio. This figure allows for evaluation of compounds with different R∞ values and C_{I}/C_{T} max ratios. For example, an analyte/IS combination used in a method with a figure of merit of 10, or less, can be expected to have a noticeable bias at the highest concentration. For calculations of ‘Theoretical R’ Equation 6 recited herein can be used, by setting A equal to 1. The ‘Percent of Ideal’ represents the percent of signal (R) of an ideal linear model where equivalent concentrations of analyte and IS are assumed to yield equivalent signal intensity and where no IISI exists. For single mass spectrometry (MS) methods, R∞ can be estimated as the relative abundance of the M+0 analyte isotope to the isotope occurring at the mass of the IS. For tandem MS methods R∞ is determined as described in certain method embodiments herein.

As can be seen from FIGS. 9A and 9B, in some aspects compounds with R∞ values of 40,000 will tolerate extremely low IS concentrations without significant influence on linear quantitation. In other aspects, compounds with very low R∞, require very high IS concentration to minimize IISI. In some embodiments it can be advantageous to determine the R∞ value early during method development and an estimate of non-linearity made.

The present approach could be classed as a “model-driven” calibration strategy. By this it is meant that one can start with the underlying physical properties of the system and the realization that isotopic peaks from the analyte may interfere with the IS and vice versa. When the ratio is taken between the analyte and IS peaks the physical model predicts that the calibration equation is constrained to a specific functional form. The calibration data, which may include a separate determination of some parameters, is then used to calculate the parameters in the calibration equation.

Because the parameters R∞ and R0 can be determined with high accuracy, all the statistical power of a set of calibrators in a run is concentrated into providing the best value for a single adjustable parameter, A, rather than being diluted into providing values for two parameters, a slope and intercept. Thus, this calibration strategy provides better precision as well as better accuracy in many cases.

It is understood that the above-described methods, arrangements and/or modes of operation are only illustrative of preferred embodiments of the present invention. Numerous modifications and alternative arrangements may be devised by those skilled in the art without departing from the spirit and scope of the present invention and the appended claims are intended to cover such modifications and arrangements. Thus, while specific embodiments of the present invention have been described with particularity and detail, it will be apparent to those of ordinary skill in the art that variations including, but not limited to, variations in size, amount, materials, function and manner of operation and use may be made without departing from the principles and concepts set forth herein.

1. A method of quantifying a target analyte in a mass spectrometry sample comprising:
introducing a calibration standard for a target analyte, an isotope-labeled internal standard for the target analyte, and a test sample into a mass spectrometer;
collecting ion intensity data for the calibration standard, the isotope-labeled internal standard, and the test sample from the mass spectrometer with a data module of a computing device operatively associated with the mass spectrometer;
calculating ion intensities of the target analyte (I_{T}) and internal standard (I_{I}) masses using the following equations:
I_{T}=F₁C_{T}+F₃C_{I}
and
I_{I}=F₂C_{T}+F₄C_{I},
wherein F₁ represents the relative ion intensity contribution for a target isotope of the target analyte, F₂ represents the relative ion intensity contribution for an internal standard isotope impurity of the target analyte, F₃ represents the relative ion intensity contribution of target isotope impurity from the internal standard, and F₄ represents the relative ion intensity contribution of internal standard isotope from the internal standard, and
wherein C_{T} is the concentration of the target analyte and C_{I} is the concentration of the internal standard;
correcting the collected ion intensity data for isotopic interference using a regression equation that comprises the following algorithm:
$$R = A \frac{( {C}_{T} + \frac{{R}_{0}}{A} {C}_{I} )}{( \frac{A}{{R}_{∞}} {C}_{T} + {C}_{I} )}$$
wherein R represents the peak area ratio between the target analyte and the internal standard,
A represents an adjustable parameter, and
R_{∞} and R₀ represent experimentally determined constant values,
wherein R_{∞} equals F₁/F₂, R₀ equals F₃/F₄, and A equals F₁/F₄;
quantifying an amount of the target analyte in the test sample using the corrected ion intensity data; and
reporting the amount of the target analyte in the test sample.

2. (canceled)

3. The method of claim 1, wherein the regression equation is a non-linear regression equation.

4. The method of claim 3, wherein the non-linear regression equation provides an accurate fit to for quantitative data in the presence of isotope to internal standard interference (IISI).

5. The method of claim 1, wherein the adjustable parameter is determined at the time of calibration of the mass spectrometer for operation.

6. The method of claim 1, wherein the adjustable parameter is determined upon collection of the internal standard and test sample data.

7. The method of claim 1, wherein both R_{∞} and R₀ constant values are used in correcting the data.

8. (canceled)

9. (canceled)

10. (canceled)

11. (canceled)

12. (canceled)

13. (canceled)

14. The method of claim 1, wherein the correction improves quantitation accuracy when contains an impurity that contributes to a signal received by the mass spectrometer from the internal standard.

15. The method of claim 1, wherein the correction improves quantitation accuracy when the internal standard contains an impurity that contributes to a signal received by the mass spectrometer from the target analyte.

16. The method of claim 1, wherein quantifying an amount of target analyte in the sample includes determining a correct peak area for the target analyte using the corrected data and converting the peak area determination into a concentration value for the target analyte.

17. The method of claim 1, wherein correcting data occurs in a data correction module of a computing device and quantification of target analyte concentration in the sample occurs in a quantification module of a computing device.

18. A method of modeling non-linear calibration behavior of mass spectrometry resulting from isotopic interference between a target analyte and an internal standard comprising:
introducing a calibration standard for a target analyte and an isotope-labeled internal standard for the target analyte into a mass spectrometer;
obtaining ion intensity data output from a mass spectrometer for the calibration standard and the internal standard with a data collection module of a computing device operatively associated with the mass spectrometer;
calculating ion intensities of the target analyte (I_{T}) and internal standard (I_{I}) masses using the following equations:
I_{T}=F₁C_{T}+F₃C_{I}
and
I_{I}=F₂C_{T}+F₄C_{I},
wherein F₁ represents the relative ion intensity contribution for a target isotope of the target analyte, F₂ represents the relative ion intensity contribution for an internal standard isotope impurity of the target analyte, F₃ represents the relative ion intensity contribution of target isotope impurity from the internal standard, and F₄ represents the relative ion intensity contribution of internal standard isotope from the internal standard, and
wherein C_{T} is the concentration of the target analyte and C_{I} is the concentration of the internal standard;
processing the ion intensity data by applying a non-linear regression algorithm to the data using a data correction module of a computing device operatively associated with the mass spectrometer, wherein the non-linear regression algorithm comprises the equation of:
$$R = A \frac{( {C}_{T} + \frac{{R}_{0}}{A} {C}_{I} )}{( \frac{A}{{R}_{∞}} {C}_{T} + {C}_{I} )}$$
wherein R represents the peak area ratio between the target analyte and the internal standard,
A represents an adjustable parameter, and
R_{∞} and R₀ represent experimentally determined constant values,
wherein R_{∞} equals F₁/F₂, R₀ equals F₃/F₄, and A equals F₁/F₄; and
using the processed ion intensity data to reduce isotopic interference induced error in reported values for the target analyte.

19. (canceled)

20. A system for quantifying a concentration of a target analyte in a sample analyzed with a mass spectrometer comprising:
a data collection module of a computing device operatively associated with the mass spectrometer, said collection module being adapted for collection of data output from a mass spectrometer;
a data correction module of a computing device operatively associated with the mass spectrometer, said correction module being adapted for correcting data collected by the data collection module, said data correction module having a non-linear regression logic algorithm that includes the following:
$$R = A \frac{( {C}_{T} + \frac{{R}_{0}}{A} {C}_{I} )}{( \frac{A}{{R}_{∞}} {C}_{T} + {C}_{I} )}$$
wherein R_{∞} is a constant equal to F₁/F₂; R₀ is a constant equal to F₃/F₄; A equals F₁/F₄,
wherein F₁ represents the relative ion intensity of a target isotope of the target analyte; F₂ represents the relative ion intensity of an internal standard isotope impurity of the target analyte;
F₃ represents the relative ion intensity of the target isotope impurity of an internal standard; and
F₄ represents the relative ion intensity of the internal standard isotope of the internal standard, and
wherein C_{T} is the concentration of the target analyte and C_{I} is the concentration of the internal standard;
a quantification module nontransitorily programmed with an algorithm capable of determining correct peak area for the target analyte using the corrected data and converting the peak area determination into a quantified value for the target analyte in the sample; and
a reporting module for reporting the target analyte concentration in the sample,
wherein said modules are contained on or in communication with a computing device capable to operating said modules.
